(19) United States
(12) Patent Application Publication
(10) Pub. No.: US 2007/0131044 A1
(43) Pub. Date: Jun. 14, 2007

(54) Electromagnetic gyro

(76) Inventor: Chen-Chung Wu, TaiPei Hsien (TW)

Correspondence Address: HAMRE, SCHUMANN, MUELLER & LARSON, P.C., P.O. BOX 2902, MINNEAPOLIS, MN, 55402-0902, US

(21) Appl. No.: 11/290,773

(22) Filed: Nov. 30, 2005

(51) Int. Cl. G01C 19/08; F21L 13/00

(52) U.S. Cl. 74/5 R; 446/233; 362/35; 362/192

(57) ABSTRACT

An electromagnetic gyro comprises a gyro body which defines a resonance circuit and at least one LED; and a base forming a self-excitation multivibrator; wherein said resonance circuit creates an alternating current induced by a variation magnetic field founded by said self-excitation multivibrator. In accordance with the present invention the electricity energy has been passed by the coupling among the windings to make the rotating gyro body light, without adding a battery therein. The circuit construction is also simple. These LEDs have high luminance through different combination of colors of which can achieve wonderful effect when the gyro body rotates. As a further improvement, there adds at least one LED in the base thereby having a function of illumination.

### BACKGROUND OF THE INVENTION

1. Field of the Invention

The present invention relates to a gyro, and more especially to an electromagnetic gyro utilizing electromagnetic conversion and magnetoelectric conversion.

2. Description of the Prior Art

Current magnetic gyros generally include a magnetic gyro body and a magnetic base wherein the magnetic base further includes a housing and a permanent magnet. In use, place the gyro body onto the base and rotate the gyro body, with the effect of the magnetic force between the gyro body and the base, the gyro body will keep rotation. However, this common gyro has single function of rotation and can not bring user more pleasure.

### BRIEF SUMMARY OF THE INVENTION

A primary object of the present invention is to provide an electromagnetic gyro which utilizes electromagnetic conversion and magnetoelectric conversion.

To achieve the above-mentioned object, an electromagnetic gyro comprises a gyro body which defines a resonance circuit and at least one LED; and a base forming a self-excitation multivibrator; wherein said resonance circuit creates an alternating current induced by a variation magnetic field founded by said self-excitation multivibrator.

In accordance with the present invention, the electricity energy has been passed by the coupling among the windings to make the rotating gyro body light, without adding a battery therein. The circuit construction is also simple. These LEDs have high luminance through different combination of colors of which can achieve wonderful effect when the gyro body rotates. As a further improvement, there adds at least one LED in the base thereby having a function of illumination.

Other objects, advantages and novel features of the present invention will become more apparent from the following detailed description when taken in conjunction with the accompanying drawings, in which:

### BRIEF DESCRIPTION OF THE DRAWINGS

FIG. 1 is a circuit construction view of a first embodiment of an electromagnetic gyro in accordance with the present invention; and

FIG. 2 is a circuit construction view of a second embodiment of the electromagnetic gyro in accordance with the present invention.

### DETAILED DESCRIPTION OF THE INVENTION

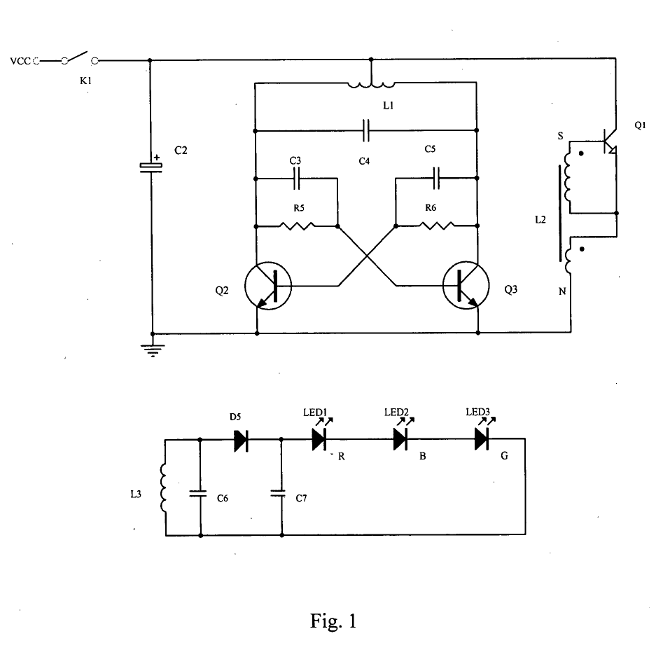

Referring to FIG. 1, an electromagnetic gyro in accordance with the present invention includes a gyro body and a base. According to a first embodiment, the base includes a self-excitation multivibrator and a winding L2. The self-excitation multivibrator includes transistors Q2, and Q3, capacitors C3, C4, and C5, resistances R5, and R6, and a winding L1. Both emitters are connected together to ground. The resistance R5 and the capacitor C3 are in parallel connection and both are connected between a collector of the transistor Q2 and a base of the transistor Q3. The resistance R6 and the capacitor C5 are in parallel connection and both are connected between a collector of the transistor Q3 and a base of the transistor Q2. The winding L1 and the capacitor C4 are in parallel connection and both determine the vibration frequency of the self-excitation multivibrator. The winding L1 is connected to ground. It should be understood that the self-excitation multivibrator can not be limited to the solution disclosed in this embodiment. Any self-excitation multivibrator well known by the skilled in the art can be applied to the present invention. The winding L2 is an electromagnet which connects the winding L1 through a transistor Q1. The winding L2 forms an inductive portion and a drive portion and both coil up coaxially onto a winding frame having an iron core. Through the right handed helix rule, the upper portion of the winding L2 is determined as an S pole.

The gyro body forms a magnet therein (not shown) and includes a resonance circuit, a diode D5, a capacitor C7 and three LEDs 1-3 having different colors. The resonance circuit includes a winding L3 and a capacitor C6 both connected in parallel. The amount and color of these LEDs can be adjusted according to requirements.

In use, turn on a switch K1, the self-excitation multivibrator begins to work. The winding L1 creates a variation magnetic field. Place the gyro body above the base and rotate, the winding L3 is induced by this variation magnetic field to generate an alternating current. This alternating current is commutated by the diode D5 and is filtered by the capacitor C7, and then drives the LEDs 1-3 to light. The reason that the capacitor C6 and the winding L3 are in parallel connection is to ensure that its resonance frequency is equal to the operating frequency of the self-excitation multivibrator, so that the winding L3 can generate a maximal current, that is, has a supreme efficiency. Meanwhile when the S pole of the magnet in the gyro body comes close to the iron core in the base, the inductive portion of the winding L2 creates an electromotive force to turn on the transistor Q1. Then the drive portion of the winding L2 founds a magnetic field by electrified to push the S pole in the gyro body goes away from the iron core. Because of rotation of the gyro body, the magnet is pushed continuously to make the gyro body speed up whereby the gyro body keeps rotation. When the gyro is far away from the iron core, the electromotive force is not enough to turn on the transistor Q1, and then the gyro body rotates freely without push. When the gyro body returns to a position adjacent to the iron core with speed descending, this course above-mentioned will repeat. Additionally, in order to prevent the winding L2 from the variation magnetic field created by the winding L1, a hoop (not shown) is used to shield the winding L2.

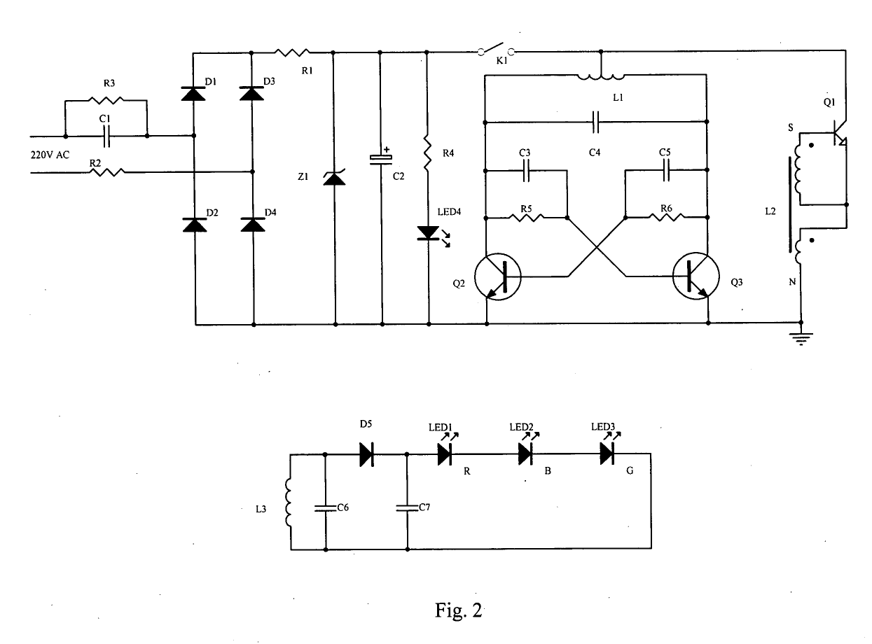

Referring to FIG. 2, in a second embodiment of the present invention, the circuit construction of the gyro body is substantially identical to that of the first embodiment. Compared with the base of the first embodiment, there adds a bridge rectifying circuit which includes four diodes D1-D4 in the base of the second embodiment. A resistance—capacitance voltage reduction circuit which includes a capacitor C1 and a resistance R3 both connected in parallel is located between the bridge rectifying circuit and an alternating power supply of 220V. A light-emitting diode LED4 is arranged between the bridge rectifying circuit and the self-excitation multivibrator, and it serves as an illumination when be powered on. The principle and work procedure of the LEDs 1-3 to light is the same as that of the first embodiment, so a detailed description is omitted here.

In accordance with the present invention the electricity energy has been passed by the coupling among the windings to make the rotating gyro body light, without adding a battery therein. The circuit construction is also simple. These LEDs have high luminance through different combination of colors of which can achieve wonderful effect when the gyro body rotates. As a further improvement, there adds at least one LED in the base thereby having a function of illumination.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electromagnetic gyro comprising:
a gyro body which defines a resonance circuit and at least one LED; and
a base forming a self-excitation multivibrator;
wherein said resonance circuit creates an alternating current induced by a variation magnetic field founded by said self-excitation multivibrator.

2. The electromagnetic gyro as claimed in claim 1, wherein said resonance circuit includes a winding (L3) and a capacitor (C6) both connected in parallel.

3. The electromagnetic gyro as claimed in claim 1, wherein said gyro body further includes a diode (D5) and a capacitor (C7) which are connected between said resonance circuit and said at least one LED in turn.

4. The electromagnetic gyro as claimed in claim 1, wherein said self-excitation multivibrator includes transistors (Q2, Q3), capacitors (C3, C4, and CS), resistances (R5, R6), and a winding (L1).

5. The electromagnetic gyro as claimed in claim 4, wherein said resistance (R5) and said capacitor (C3) are in parallel connection and both are connected between a collector of said transistor (Q2) and a base of said transistor (Q3).

6. The electromagnetic gyro as claimed in 4, wherein said resistance (R6) and said capacitor (C5) are in parallel connection and both are connected between a collector of said transistor (Q3) and a base of said transistor (Q2).

7. The electromagnetic gyro as claimed in 4, wherein said winding (L1) and said capacitor (C4) are in parallel connection and both determine the vibration frequency of said self-excitation multivibrator.

8. The electromagnetic gyro as claimed in 1, wherein the resonance frequency of said resonance circuit is equal to the operating frequency of said self-excitation multivibrator.

9. The electromagnetic gyro as claimed in claim 1, wherein said base further includes a bridge rectifying circuit which includes four diodes (D1-D4).

10. The electromagnetic gyro as claimed in claim 9, wherein a resistance—capacitance voltage reduction circuit which includes a capacitor (C1) and a resistance (R3) both connected in parallel is located between said bridge rectifying circuit and an alternating power supply of 220V.

11. The electromagnetic gyro as claimed in claim 1, wherein said base further includes a winding (L2) which is an electromagnet which connects said winding (L1) through a transistor (Q1).

12. The electromagnetic gyro as claimed in claim 11, wherein said winding (L2) forms an inductive portion and a drive portion and both coil up coaxially onto a winding frame having an iron core.

13. An electromagnetic gyro comprising:
a gyro body which defines a first means for magnetoelectric conversion; and
a base defines a second means for electromagnetic conversion;
wherein said second means create a variation magnetic field by electrified to induce said first means to generate an alternating current.

14. The electromagnetic gyro as claimed in claim 13, wherein said first means includes a winding (L3) and a capacitor (C6) both connected in parallel.

15. The electromagnetic gyro as claimed in claim 14, wherein said first means further includes a diode (D5) and a capacitor (C7) which are connected between said resonance circuit and said at least one LED in turn.

16. The electromagnetic gyro as claimed in claim 13, wherein said second means defines a self-excitation multivibrator which includes transistors (Q2, Q3), capacitors (C3, C4, and C5), resistances (R5, R6), and a winding (L1).

17. The electromagnetic gyro as claimed in claim 16, wherein said resistance (R5) and said capacitor (C3) are in parallel connection and both are connected between a collector of said transistor (Q2) and a base of said transistor (Q3).

18. The electromagnetic gyro as claimed in claim 16, wherein said resistance (R6) and said capacitor (C5) are in parallel connection and both are connected between a collector of said transistor (Q3) and a base of said transistor (Q2).

19. The electromagnetic gyro as claimed in claim 16, wherein said winding (L1) and said capacitor (C4) are in parallel connection and both determine the vibration frequency of said self-excitation multivibrator.
